(19) United States
(12) Patent Application Publication
(10) Pub. No.: US 2024/0109497 A1
(43) Pub. Date: Apr. 4, 2024

(54) OVERHEAD CONSOLE

(71) Applicant: MORIROKU TECHNOLOGY COMPANY, LTD., Tokyo (JP)

(72) Inventor: Suzuka ISO, Tokyo (JP)

(21) Appl. No.: 18/467,353

(22) Filed: Sep. 14, 2023

(30) Foreign Application Priority Data
Oct. 4, 2022 (JP) 2022-160508

(51) Int. Cl. B60R 7/04

(52) U.S. Cl. CPC B60R 7/04; B60R 2011/0028

(57) ABSTRACT

An overhead console includes a storage box that can be stored in a panel. The storage box includes a bottom having an outer surface formed along a connection surface, a wall having an outer surface formed along a lower surface, and a shaft protruding in a vehicle width direction. A recess of the panel includes a first slide groove which extends in a vehicle front-rear direction and in which the shaft is slidable. When the storage box is in a stored position, the shaft is located at a front end of the first slide groove. When the storage box is in a use position, the shaft is located at a rear end of the first slide groove.

### FIELD OF THE INVENTION

The present invention relates to an overhead console provided on a ceiling of a passenger compartment.

### BACKGROUND

An overhead console in which an object can be stored may be provided in a passenger compartment of a passenger car or the like. A technique of the related art related to the overhead console is disclosed in JP-A-2005-178674.

The overhead console includes a panel provided on a ceiling of a passenger compartment, and a storage box that can be store in a recess of the panel. Side walls of the recess include shafts that rotatably support the storage box. When the storage box is in a stored position where the storage box is stored in the recess, the storage box is held in the stored position by the engagement of a hook and a pin.

When the engagement of the hook and the pin is released, the storage box swings downward around the shaft from the stored position. The storage box is locatable in a use position where an occupant can use the storage box.

When a small occupant is seated on a seat and uses the storage box, the distance from the occupant to the storage box increases, so that the overhead console becomes inconvenient to use.

An object of the invention is to provide an overhead console that allows a storage box to be brought closer to an occupant when the storage box is used.

### SUMMARY

According to a first aspect, there is provided an overhead console including a panel provided on a ceiling of a passenger compartment, and a storage box that can be stored in a recess of the panel. The storage box is locatable in a stored position where the storage box is stored in the recess and in a use position where the storage box is swung downward from the stored position and is usable by an occupant. The panel is formed in a stepped shape in a vehicle height direction, and has a lower surface lower than a ceiling surface, and a connection surface connecting the lower surface and the ceiling surface. The recess is formed from the lower surface to the connection surface of the panel. A first slide groove extending in a vehicle front-rear direction is provided. The storage box in the stored position includes a bottom having an outer surface formed along the connection surface, a wall having an outer surface formed along the lower surface, and a shaft that protrudes in a vehicle width direction and that is slidable with respect to the first slide groove. When the storage box is in the stored position, the shaft is located at a front end of the first slide groove. When the storage box is in the use position, the shaft is located at a rear end of the first slide groove.

According to the invention, it is possible to provide the overhead console that allows the storage box to be brought closer to the occupant when the storage box is used.

### BRIEF DESCRIPTION OF THE DRAWINGS

FIG. 1 is a view describing a passenger compartment of a vehicle provided with an overhead console of a first embodiment;

FIG. 2 is a perspective view of a recess of a panel and a storage box forming the overhead console illustrated in FIG. 1;

FIG. 3 is a cross-sectional view of the storage box in a stored position;

FIG. 4A is a view describing the storage box in a slide position, FIG. 4B is a view describing the storage box in a slide completion position, and FIG. 4C is a view describing the storage box in a swing position;

FIG. 5A is a perspective view of the storage box in a use position, and FIG. 5B is a side view of the storage box in the use position;

FIG. 6A is a perspective view of the storage box with a mirror opened, and FIG. 6B is a view describing actions of the overhead console of the first embodiment;

FIG. 7A is a view schematically describing a storage box in the stored position in an overhead console according to a second embodiment, FIG. 7B is a view describing the storage box in a swing completion position, and FIG. 7C is a view describing the storage box in the use position;

FIG. 8 is a perspective view of a recess of a panel and a storage box forming an overhead console according to a third embodiment;

FIG. 9A is a view schematically describing the storage box in the stored position, and FIG. 9B is a view describing the storage box in the swing completion position;

FIG. 10 is a view describing the storage box in the use position;

FIG. 11A is a view schematically describing a storage box in the stored position in an overhead console according to a fourth embodiment, and FIG. 11B is a view describing the storage box in the swing completion position;

FIG. 12 is a view describing the storage box in the use position; and

FIG. 13A is a view describing a storage box in the stored position in an overhead console according to a fifth embodiment, FIG. 13B is a view describing the storage box in the swing position, and FIG. 13C is a view describing the storage box in the use position.

### DETAILED DESCRIPTION

Embodiments will be described with reference to the accompanying drawings. Incidentally, left-right indicates left-right with respect to an occupant of a vehicle (vehicle width direction), and front-rear indicates front-rear with respect to a traveling direction of the vehicle. In addition, in the drawings, Fr represents the front, Rr represents the rear, Le represents the left when viewed from the occupant, Ri represents the right when viewed from the occupant, Up represents the top or up, and Dn represents the bottom or down.

### First Embodiment

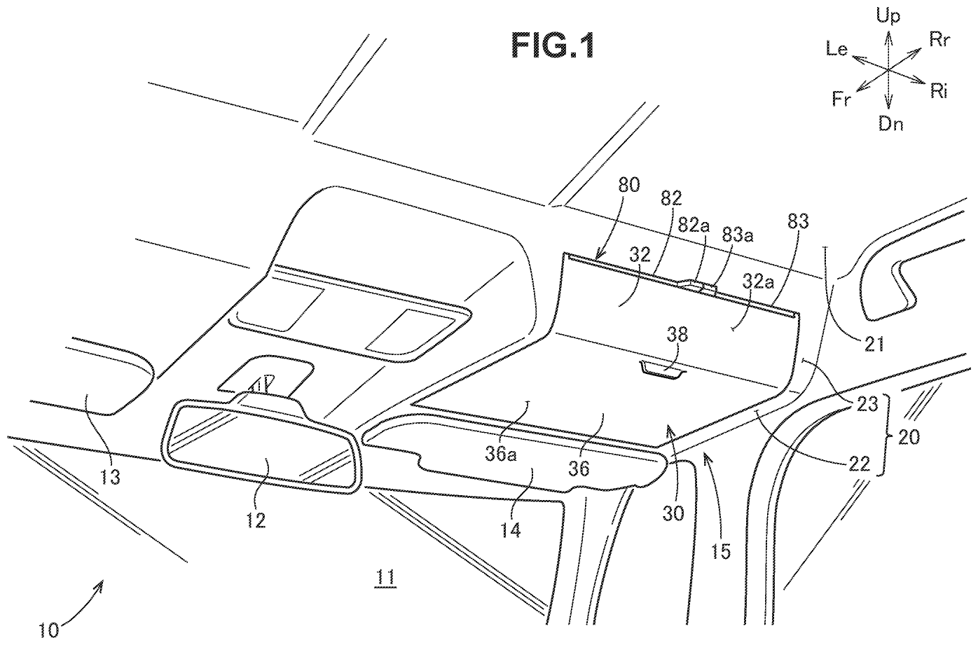

FIG. 1 illustrates a passenger compartment 11 of a vehicle 10 (for example, four-wheeled compact car). A panel 20 covering a ceiling, an interior mirror 12, and sun visors 13 and 14 located on both sides of the interior mirror 12 in the vehicle width direction are provided in the passenger compartment 11. An overhead console 15 according to a first embodiment is provided behind the sun visor 14 on a driver's seat side. Incidentally, the position where the overhead console 15 is provided is not limited to above a driver's seat, and can be changed as appropriate according to the position of the occupant seated inside the vehicle.

The panel 20 has a stepped shape in the vehicle height direction. In detail, the panel 20 has a lower surface 22 lower than a ceiling surface 21, and a connection surface 23 connecting the lower surface 22 and the ceiling surface 21. The connection surface 23 faces rearward. The lower surface 22 is located in front of the ceiling surface 21. Incidentally, although not illustrated, the panel 20 may be fixed to the ceiling surface 21 using clips or the like.

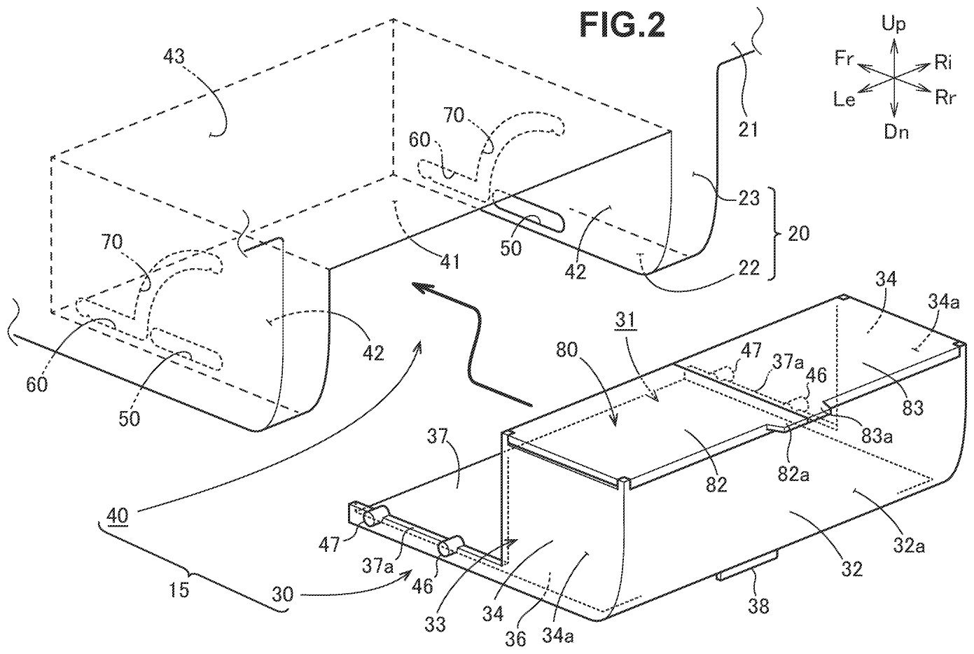

Referring to FIG. 2, the overhead console 15 includes a storage box 30 in which an object can be stored, and a recess 40 in which the storage box 30 can be stored.

The recess 40 is formed from the lower surface 22 to the connection surface 23 of the panel 20. Namely, the recess 40 is open downward. The recess 40 is defined by a top plate surface 41 facing downward, a pair of side wall surfaces 42 and 42 extending downward from both edges in the vehicle width direction of the top plate surface 41 and facing each other, and a front wall surface 43 extending downward from a front edge of the top plate surface 41.

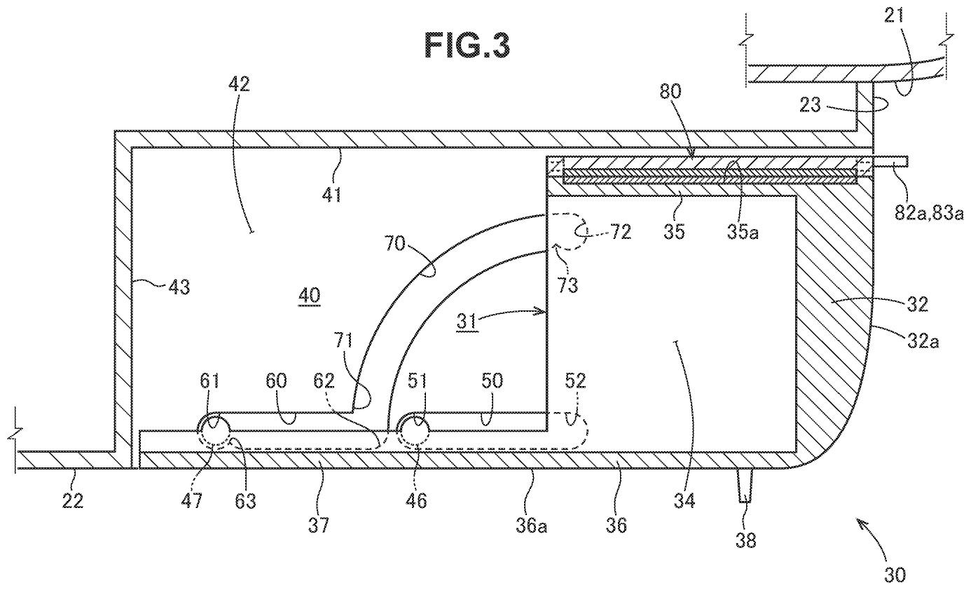

Referring to FIG. 2 and FIG. 3, the storage box 30 is configured by integrating a bottom 32 having a substantially rectangular shape and located opposite to an opening 31 serving as an entrance for an object and a peripheral wall 33 extending in a direction from a peripheral edge of the bottom 32 toward the opening 31. The bottom 32 and the opening 31 have the vehicle width direction as a longitudinal direction.

As illustrated in FIG. 3, a position where the storage box 30 is stored in the recess 40 is referred to as a stored position. Hereinafter, a configuration of the storage box 30 will be described with respect to when the storage box 30 is in the stored position.

The peripheral wall 33 of the storage box 30 is configured by integrating a pair of first walls 34 and 34 having a plate shape and extending from both edges of the bottom 32 in the vehicle width direction to an opening 31 side, a second wall 35 having a plate shape and extending from an upper edge of the bottom 32 to the opening 31 side, and a third wall 36 having a plate shape and extending from a lower edge of the bottom 32 to the opening 31 side.

The opening 31 of the storage box 30 faces forward. An outer surface 34a of the first wall 34 faces the side wall surface 42 of the recess 40 with a slight gap therebetween.

An outer surface 32a (surface facing the passenger compartment 11) of the bottom 32 is formed along the connection surface 23 of the panel 20. An outer surface 36a (surface facing the passenger compartment 11) of the third wall 36 is formed along the lower surface of the panel 20.

The third wall 36 includes an extension 37 extending forward from an edge of the opening 31 of the storage box 30. Edges 37a and 37a on both sides of the extension 37 in the vehicle width direction include a pair of shafts 46 and 46 having a columnar shape and having an axis in the vehicle width direction. Each of the shafts 46 protrudes toward the side wall surface 42 of the recess 40. Each of the shafts 46 is located in front of the opening 31. Incidentally, the shape and size of the shaft 46 can be changed as appropriate.

The edges 37a on both the sides of the extension 37 in the vehicle width direction include a pair of protrusions 47 and 47 protruding in the same direction as the shafts 46. The protrusions 47 are located in front of the shafts 46. Incidentally, the shape and size of the protrusions 47 are not limited to a columnar shape, and the cross-sectional shape thereof can be changed as appropriate.

The side wall surfaces 42 of the recess 40 include first slide grooves 50 and 50 which extend in a vehicle front-rear direction and in which the shafts 46 are slidable. The first slide grooves 50 support the shafts 46 such that the storage box 30 is slidable. A width of the first slide grooves 50 is slightly larger than or equal to a diameter of the shafts 46.

The side wall surfaces 42 of the recess 40 include second slide grooves 60 and 60 which extend in the vehicle front-rear direction and in which the protrusions 47 are slidable. A width of the second slide grooves 60 is slightly larger than or equal to a diameter of the protrusions 47. The second slide grooves 60 are located in front of the first slide grooves 50. A dimension of the first slide grooves 50 and a dimension of the second slide grooves 60 with respect to the vehicle front-rear direction are equal.

When the storage box 30 is in the stored position, the shafts 46 are located at front ends 51 of the first slide grooves 50, and the protrusions 47 are located at front ends 61 of the second slide grooves 60. The second slide grooves 60 include restrictions 63 that restrict the protrusions 47 located at the front ends 61 of the second slide grooves 60. The restrictions 63 are configured by protruding parts of wall surfaces of the second slide grooves 60, thereby narrowing the width of the second slide grooves 60. Incidentally, the position, number, and shape of the restrictions 63 are optional. The third wall 36 includes a grip 38 that extends downward from the outer surface 36a and that can be gripped by the occupant.

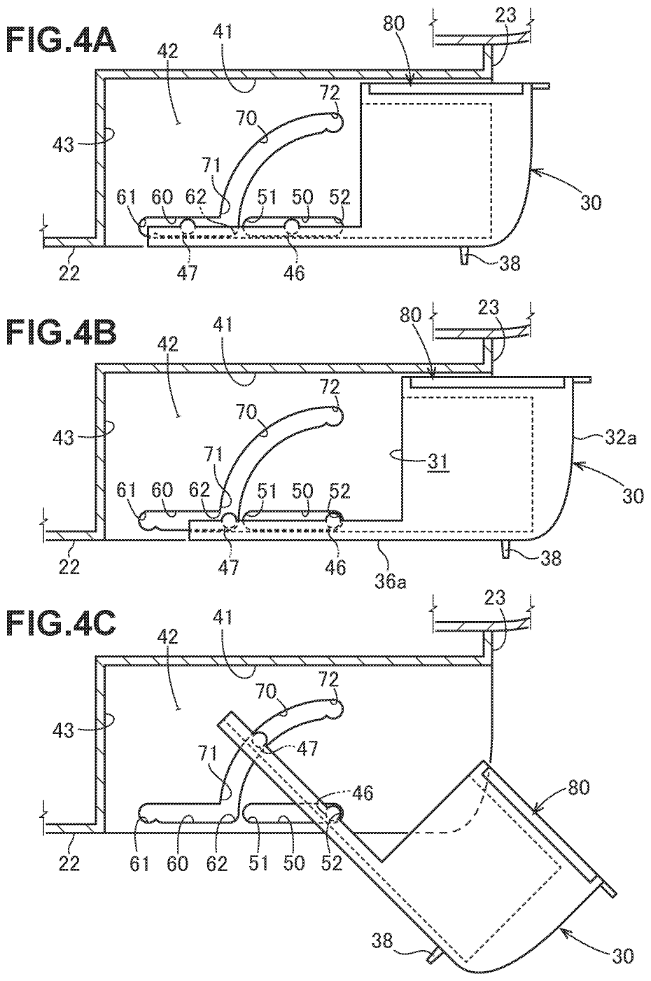

When the occupant grips the grip 38 and pulls the storage box 30, which is in the stored position, rearward, as illustrated in FIG. 4A, the storage box 30 moves rearward. A position where the shafts 46 slide with respect to the first slide grooves 50 and the protrusions 47 slide with respect to the second slide grooves 60 is referred to as a slide position.

Referring to FIG. 4B, a state where the shafts 46 are located at rear ends 52 of the first slide grooves 50 and the protrusions 47 are located at rear ends 62 of the second slide grooves 60 is referred to as a slide completion position. When the storage box 30 is in the slide completion position, the outer surface 32a of the bottom 32 of the storage box 30 is located behind the connection surface 23. The opening 31 is located in front of the connection surface 23 (the opening 31 is located inside the recess 40). Incidentally, the opening 31 may be located behind the connection surface 23. The outer surface 36a of the third wall 36 of the storage box 30 is located on the same plane as the lower surface 22.

When the occupant releases the storage box 30 in the slide completion position, as illustrated in FIG. 4C, the storage box 30 swings downward around the shafts 46 due to its own weight (hereinafter, referred to as a swing position).

Referring to FIG. 3 and FIG. 4C, the side wall surfaces 42 of the recess 40 include escape grooves 70 and 70 through the protrusions 47 are passable when the shafts 46 are located at the rear ends 52 of the first slide grooves 50 and the storage box 30 swings around the shafts 46.

The shape of the escape grooves 70 is, for example, a circular arc with a central angle of approximately 90 degrees; however, the shape of the escape grooves 70 does not matter as long as spaces through which the protrusions 47 are passable are formed. The center of the escape grooves 70 having a circular arc shape is the axis of the shafts 46 when the shafts 46 are located at the rear ends 52 of the first slide grooves 50.

First ends 71 of the escape grooves 70 are continuous with the rear ends 62 of the second slide grooves 60. Second ends 72 of the escape grooves 70 are located above the rear ends 52 of the first slide grooves 50. Incidentally, a non-woven fabric for improving feeling when the storage box 30 is moved or a soft material or the like for providing resistance may be added to the shafts 46, the first slide grooves 50, the second slide grooves 60, and the escape grooves 70.

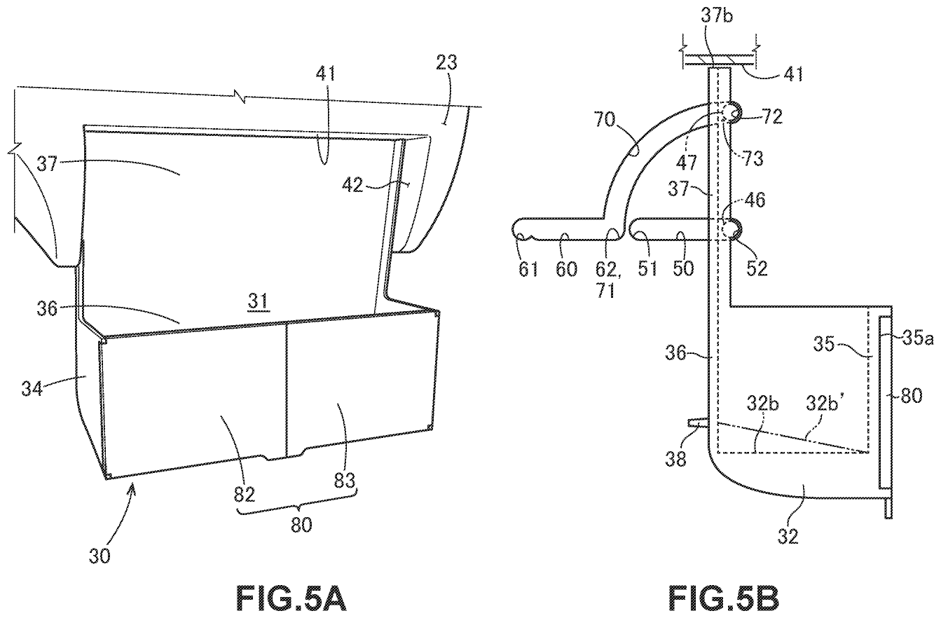

Referring to FIG. 5A and FIG. 5B, a position where the storage box 30 in the slide completion position (refer to FIG. 4B) is swung downward by approximately 90 degrees and the occupant uses the storage box 30 is referred to as a use position.

When the storage box 30 is in the use position, the shafts 46 are located at the rear ends 52 of the first slide grooves 50. The protrusions 47 are located at the second ends 72 of the escape grooves 70. The escape grooves 70 include restrictions 73 that restrict the protrusions 47 located at the second ends 72. A pair of the restrictions 73 and 73 are configured by protruding parts of wall surfaces of the escape grooves 70, thereby narrowing the width of the escape grooves 70.

When the storage box 30 is in the use position, the opening 31 of the storage box 30 faces upward. A bottom surface 32b of the bottom 32 of the storage box 30 is horizontal. The third wall 36 extends in an up-down direction. The third wall 36 is located in front of the second wall 35. An outer surface 35a of the second wall 35 faces rearward. A tip 37b of the extension 37 of the third wall 36 is set such that a slight gap can be formed between the recess 40 and the top plate surface 41. Namely, the extension 37 covers the rear of the recess 40 such that the inside of the recess 40 cannot be visually recognized.

When the storage box 30 in the use position is stored, the storage box 30 is moved in order of the swing position (refer to FIG. 4C), the slide completion position (refer to FIG. 4B), the slide position (refer to FIG. 4A), and the stored position (refer to FIG. 3). A detailed description will be omitted.

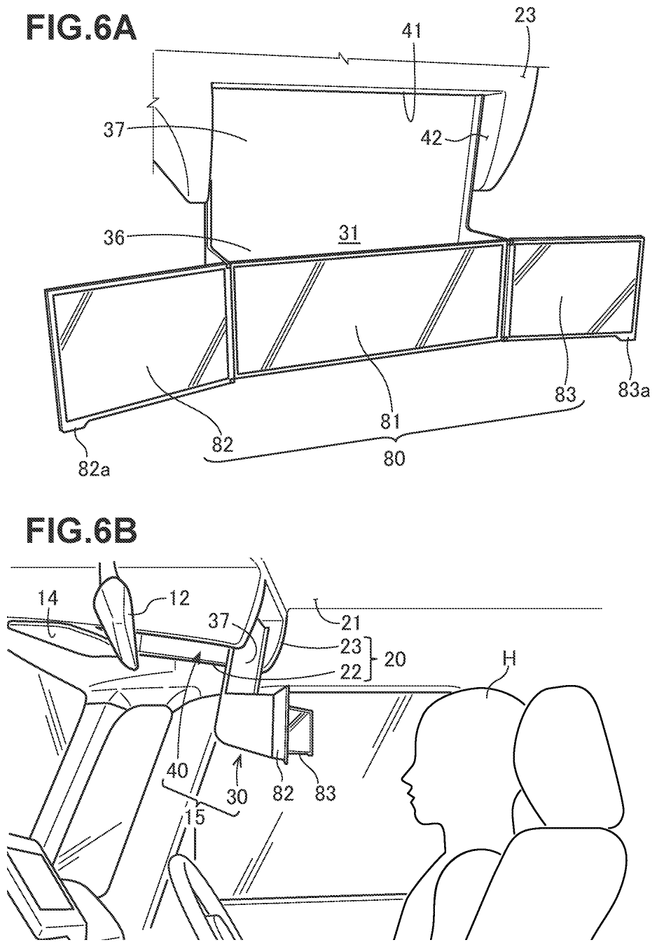

Referring to FIG. 5B and FIG. 6A, the outer surface 35a of the second wall 35 includes a three-sided mirror 80 (mirror). The three-sided mirror 80 includes a first mirror 81 attached to cover the entirety of the outer surface 35a (refer to FIG. 5B) of the second wall 35; a second mirror 82 attached to a left edge of the first mirror 81 via a hinge mechanism; and a third mirror 83 attached to a right edge of the first mirror 81 via a hinge mechanism. A grip 82a is provided at a lower end of the second mirror 82. A grip 83a is provided at a lower end of the third mirror 83.

Referring to FIG. 5A, the second mirror 82 is foldable to be able to cover a left half of the first mirror 81. The third mirror 83 is foldable to be able to cover a right half of the first mirror 81. Incidentally, the mirror attached to the outer surface 35a of the second wall 35 is not limited to the three-sided mirror 80, and may be a single mirror. Further, the shape, size, and attachment position of the single mirror can be changed as appropriate.

Firstly, the storage box 30 in the stored position (refer to FIG. 3) is locatable in the use position (refer to FIG. 5B) through the slide position (refer to FIG. 4A), the slide completion position (refer to FIG. 4B), and the swing position (refer to FIG. 4C).

In the stored position (refer to FIG. 3), the shafts 46 are located at the front ends 51 of the first slide grooves 50. In the use position (refer to FIG. 5B), the shafts 46 are located at the rear ends 52 of the first slide grooves 50.

Namely, compared to the overhead console in which the storage box in the stored position is swung as it is and is used as in the related art, when the storage box 30 is used, the storage box 30 is in a position close to the occupant. The storage box of the overhead console 15 can be brought closer to the occupant during use.

Referring to FIG. 2, secondly, further, the edges 37a on both the sides of the extension 37 in the vehicle width direction include the protrusions 47 having a columnar shape and protruding in the same direction as the shafts 46. The side wall surfaces 42 include the second slide grooves 60 in which the protrusions 47 are slidable when the shafts 46 slide with respect to the first slide grooves 50. The second slide grooves 60 extend in the vehicle front-rear direction.

If the storage box 30 includes only the shafts 46 and does not include the protrusions 47, the storage box 30 swings freely. A holding mechanism that holds the storage box in the stored position is essential. In the first embodiment, since the protrusions 47 come into contact with the wall surfaces of the second slide grooves 60, the swinging of the storage box 30 due to its own weight can be restricted. The overhead console 15 has a simple configuration that does not require a holding mechanism using a hook and a pin.

Referring to FIG. 3, the side wall surfaces 42 of the recess 40 include the escape grooves 70 through which the protrusions 47 are passable when the storage box 30 swings around the shafts 46 in a state where the shafts 46 are located at the rear ends 52 of the first slide grooves 50. For this reason, when the occupant releases the storage box 30 in the slide completion position (refer to FIG. 4B), the storage box 30 swings due to its own weight (refer to FIG. 4C). Incidentally, the width of the escape grooves 70 is slightly larger than or equal to the diameter of the protrusions 47. For this reason, the escape grooves 70 serve as guides for the storage box 30 in the swing position. The effect is also exhibited in other embodiments to be described later.

Referring to FIG. 2, thirdly, the third wall 36 includes the extension 37 extending forward from the edge of the opening 31. The extension 37 includes the pair of shafts 46. Namely, the shafts 46 are located in front of the opening 31 of the storage box 30. Compared to a case where the shafts 46 are provided on the peripheral wall 33 of the storage box 30, it can be said that the shafts 46 are set farther away from the opening 31 of the storage box 30.

Referring to FIG. 6B, with the above configuration, the use position of the storage box 30 can be lowered. Even for a small occupant, the storage box 30 becomes located in front of an occupant's head H, so that the storage box 30 becomes easier to use.

Referring to FIG. 6A, fourthly, the three-sided mirror 80 is attached to the outer surface 35a of the second wall 35. When the storage box 30 is in the use position, the occupant can use the three-sided mirror 80 as a vanity mirror. Typically, the passenger compartment 11 gradually widens in the vehicle width direction from the panel 20 of the ceiling toward the bottom. When the storage box 30 is in a low position, the three-sided mirror 80 becomes easier to open. In a state where the three-sided mirror 80 is opened, the three-sided mirror 80 is located around the occupant's face. The three-sided mirror 80 can block the line of sight from outside the vehicle, so that, for example, applying makeup inside the vehicle becomes easier.

Referring to FIG. 5B, when the storage box 30 is in the use position, the bottom surface 32b of the storage box 30 is substantially horizontal. The occupant easily places an object on the bottom surface 32b of the storage box 30. Incidentally, when the storage box 30 is in the use position, the bottom surface 32b of the storage box 30 may not be horizontal, but a bottom surface 32b′ that is inclined upward toward the front may be formed. An object placed in the storage box 30 becomes easier to take out and in, so that the inside of the storage box 30 becomes easier to see.

### Second Embodiment

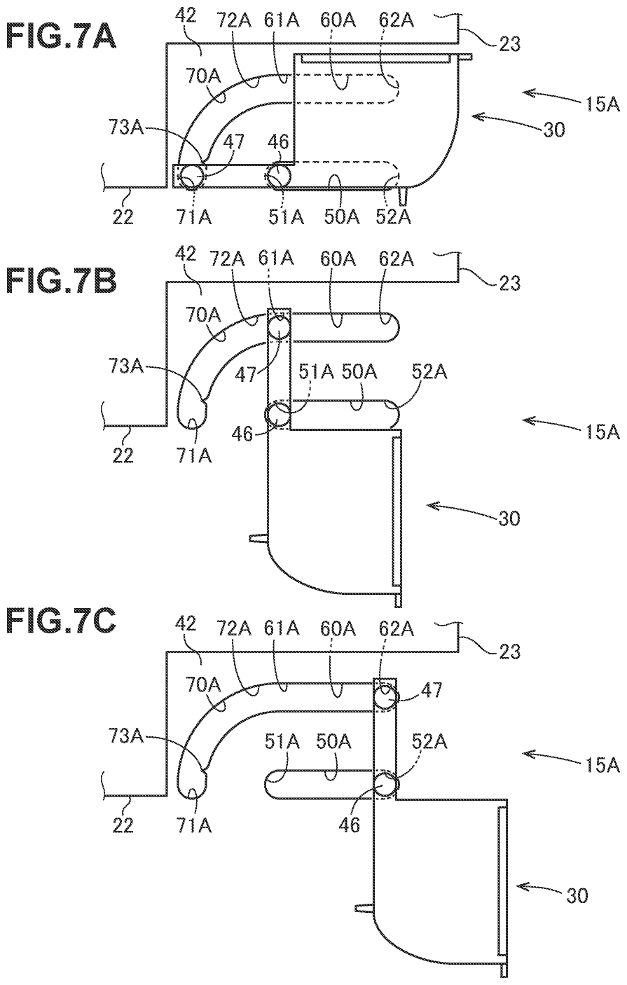

FIG. 7A illustrates an overhead console 15A according to a second embodiment. The same reference signs as in the first embodiment are assigned to configurations common to the overhead console 15 of the first embodiment, and the descriptions will be omitted.

The side wall surfaces 42 of the recess 40 include first slide grooves 50A which extend in the vehicle front-rear direction and in which the shafts 46 are slidable.

The side wall surfaces 42 include second slide grooves 60A which extend in the vehicle front-rear direction and in which the protrusions 47 are slidable. The second slide grooves 60A are located above the first slide grooves 50A. A dimension of the first slide grooves 50A and a dimension of the second slide grooves 60A with respect to the vehicle front-rear direction are the same.

The side wall surfaces 42 of the recess 40 include escape grooves 70A through which the protrusions 47 are passable when the storage box 30 swings around the shafts 46 in a state where the shafts 46 are located at front ends 51A of the first slide grooves 50A.

The escape grooves 70A have a circular arc shape with a central angle of approximately 90 degrees. The center of the escape grooves 70A is the axis of the shafts 46 located at rear ends 52A of the first slide grooves 50A. First ends 71A of the escape grooves 70A are located in front of the first slide grooves 50A. Second ends 72A of the escape grooves 70A are continuous with front ends 61A of the second slide grooves 60A.

The escape grooves 70A are provided with restrictions 73A that restrict the protrusions 47 located at the first ends 71A of the escape grooves 70A. The restrictions 73A are configured by protruding parts of wall surfaces of the escape grooves 70A, thereby narrowing the width of the escape grooves 70A. Incidentally, a non-woven fabric for improving feeling when the storage box 30 is moved or a soft material or the like for providing resistance may be added to the shafts 46, the first slide grooves 50A, the second slide grooves 60A, and the escape grooves 70A.

When the storage box 30 is in the stored position, the shafts 46 are located at the front ends 51A of the first slide grooves 50A. The protrusions 47 are located at the first ends 71A of the escape grooves 70A.

Referring to FIG. 7B, when the storage box 30 in the stored position is swung around the shafts 46 by approximately 90 degrees, the storage box 30 is located in the swing completion position. When the storage box 30 is in the swing completion position, the shafts 46 are located at the front ends 51A of the first slide grooves 50A. The protrusions 47 are located at the front ends 61A of the second slide grooves 60A.

When the storage box 30 in the swing completion position moves rearward, the shafts 46 slide rearward with respect to the first slide grooves 50A, and the protrusions 47 slide rearward with respect to the second slide grooves 60A. When the shafts 46 are located at the rear ends 52A of the first slide grooves 50A, and the protrusions 47 are located at rear ends 62A of the second slide grooves 60A, the storage box 30 is in the use position.

### Third Embodiment

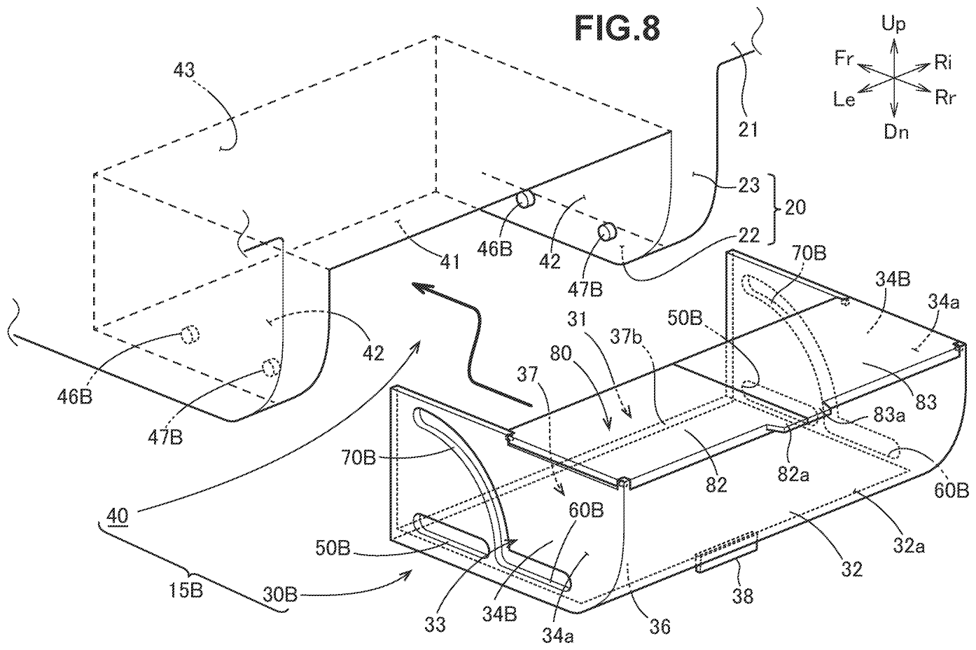

FIG. 8 illustrates an overhead console 15B according to a third embodiment. The same reference signs as in the first embodiment are assigned to configurations common to the overhead console 15 of the first embodiment, and the descriptions will be omitted.

First walls 34B and 34B of a storage box 30B extend from the edge of the opening 31 to the tip 37b of the extension 37.

The side wall surfaces 42 and 42 of the recess 40 include a pair of shafts 46B and 46B having a columnar shape and having an axis in the vehicle width direction. Each of the shafts 46B protrudes toward the first wall 34B of the storage box 30B.

The side wall surfaces 42 and 42 include a pair of protrusions 47B and 47B protruding in the same direction as the shafts 46B. Each of the protrusions 47B is located behind the shaft 46B.

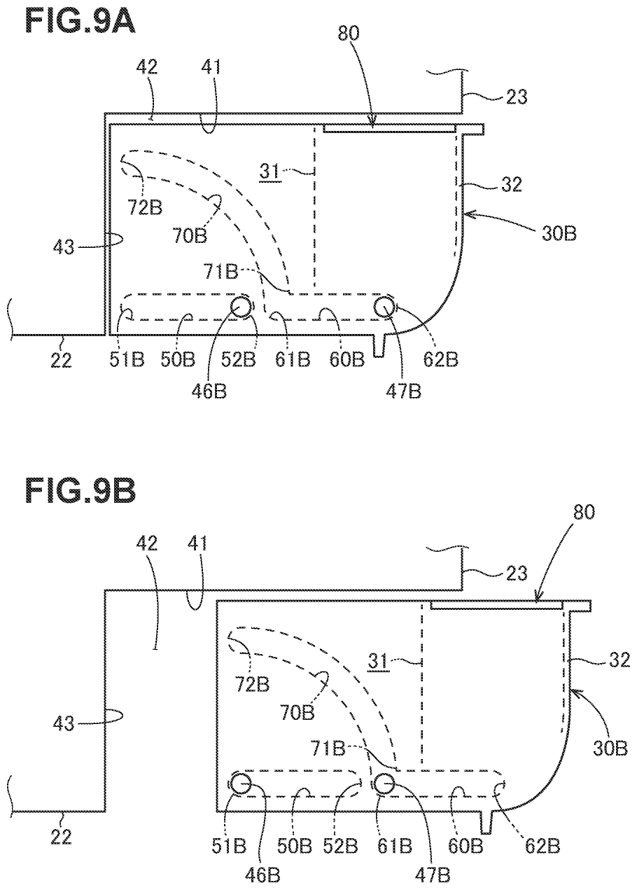

Referring to FIG. 8 and FIG. 9A, each of the first walls 34B includes a first slide groove 50B which extends in the vehicle front-rear direction and relative to which the shaft 46B is slidable. A width of the first slide groove 50B is slightly larger than or equal to a diameter of the shaft 46B.

Each of the first walls 34B include a second slide groove 60B which extends in the vehicle front-rear direction and relative to which the protrusion 47B is slidable. A width of the second slide groove 60B is slightly larger than or equal to a diameter of the protrusion 47B. The second slide groove 60B is located behind the first slide groove 50B. A dimension of the first slide groove 50B and a dimension of the second slide groove 60B with respect to the vehicle front-rear direction are equal.

When the storage box 30B is in the stored position (refer to FIG. 9A), the shafts 46B are located at rear ends 52B of the first slide grooves 50B, and the protrusions 47B are located at rear ends 62B of the second slide grooves 60B. Incidentally, the above-described restrictions (not illustrated) may be provided at the rear ends 52B of the first slide grooves 50B or the rear ends 62B of the second slide grooves 60B.

When viewed in a direction along the axis of the shafts 46B (refer to FIG. 9A), the protrusions 47B are located between the opening 31 and the bottom 32.

Referring to FIG. 9B, a state where the storage box 30B in the stored position is moved rearward, the shafts 46B are located at front ends 51B of the first slide grooves 50B, and the protrusions 47B are located at front ends 61B of the second slide grooves 60B is referred to as the slide completion position.

The first walls 34B include escape grooves 70B through which the protrusions 47B are passable when the shafts 46B are located at the front ends 51B of the first slide grooves 50B and the storage box 30B swings around the shafts 46B.

The shape of the escape grooves 70B is, for example, a circular arc with a central angle of approximately 90 degrees; however, the shape of the escape grooves 70B does not matter as long as spaces through which the protrusions 47B are passable are formed. The center of the escape grooves 70B having a circular arc shape is the axis of the shafts 46B when the shafts 46B are located at the front ends 51B of the first slide grooves 50B.

First ends 71B of the escape grooves 70B are continuous with the front ends 61B of the second slide grooves 60B. Second ends 72B of the escape grooves 70B are located above the front ends 51B of the first slide grooves 50B. Incidentally, a non-woven fabric for improving feeling when the storage box 30B is moved or a soft material or the like for providing resistance may be added to the shafts 46B, the first slide grooves 50B, the second slide grooves 60B, and the escape grooves 70B.

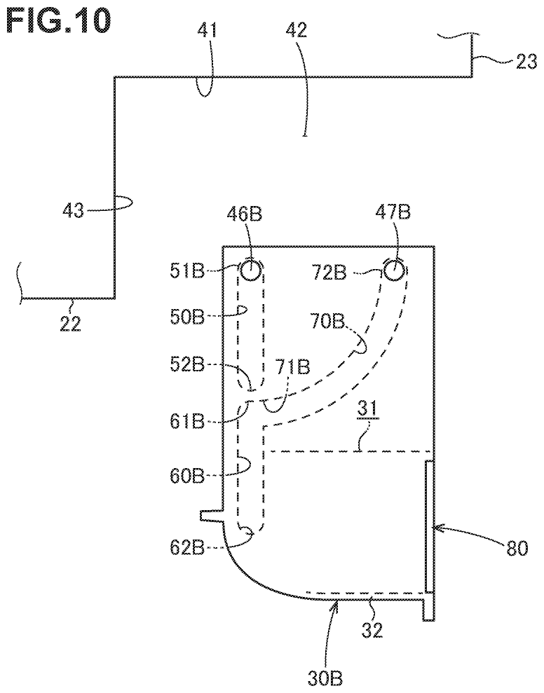

Referring to FIG. 10, a position where the storage box 30B in the slide completion position (refer to FIG. 9B) is swung downward and the occupant uses the storage box 30B is referred to as the use position. When the storage box 30B is in the use position, the shafts 46B are located at the front ends 51B of the first slide grooves 50B. The protrusions 47B are located at the second ends 72B of the escape grooves 70B. The escape grooves 70B may be provided with the above-described restrictions (not illustrated).

### Fourth Embodiment

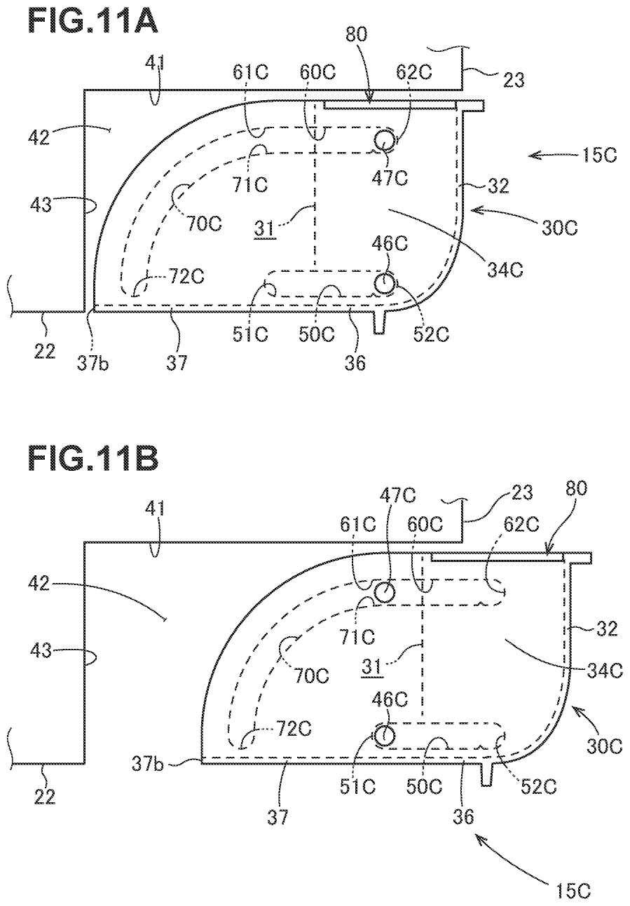

FIG. 11A illustrates an overhead console 15C according to a fourth embodiment. The same reference signs as in the first embodiment are assigned to configurations common to the overhead console 15 of the first embodiment, and the descriptions will be omitted.

First walls 34C of a storage box 30C extend from the edge of the opening 31 to the tip 37b of the extension 37.

Each of the side wall surfaces 42 includes a shaft 46C having a columnar shape and having an axis in the vehicle width direction. Each of the shafts 46C protrudes toward the first wall 34C of the storage box 30C.

Each of the side wall surfaces 42 includes a protrusions 47C protruding in the same direction as the shaft 46C. Each of the protrusions 47C is located above the shaft 46C.

Referring to FIG. 11A, the first walls 34C include first slide grooves 50C which extend in the vehicle front-rear direction and relative to which the shafts 46C are slidable. A width of the first slide grooves 50C are slightly larger than or equal to a diameter of the shafts 46C.

The first walls 34C include second slide grooves 60C which extend in the vehicle front-rear direction and relative to which the protrusions 47C are slidable. A width of the second slide grooves 60C are slightly larger than or equal to a diameter of the protrusions 47C. The second slide grooves 60C are located above the first slide grooves 50C. A dimension of the first slide grooves 50C and a dimension of the second slide grooves 60C with respect to the vehicle front-rear direction are equal.

When the storage box 30C is in the stored position (refer to FIG. 11A), the shafts 46C are located at rear ends 52C of the first slide grooves 50C, and the protrusions 47C are located at rear ends 62C of the second slide grooves 60C. Incidentally, the above-described restrictions (not illustrated) may be provided at the rear ends 52C of the first slide grooves 50C or the rear ends 62C of the second slide grooves 60C.

When viewed in a direction along the axis of the shafts 46C (refer to FIG. 11A), the shafts 46C and the protrusions 47C are located between the opening 31 and the bottom 32.

Referring to FIG. 11B, a state where the storage box 30C in the stored position is moved rearward, the shafts 46C are located at front ends 51C of the first slide grooves 50C, and the protrusions 47C are located at front ends 61C of the second slide grooves 60C is referred to as the slide completion position.

The first walls 34C include escape grooves 70C through which the protrusions 47C are passable when the shafts 46C are located at the front ends 51C of the first slide grooves 50C and the storage box 30C swings around the shafts 46C.

The shape of the escape grooves 70C is, for example, a circular arc with a central angle of approximately 90 degrees; however, the shape of the escape grooves 70C does not matter as long as spaces through which the protrusions 47C are passable are formed. The center of the escape grooves 70C having a circular arc shape is the axis of the shafts 46C when the shafts 46C are located at the front ends 51C of the first slide grooves 50C.

First ends 71C of the escape grooves 70C are continuous with the front ends 61C of the second slide grooves 60C. Second ends 72C of the escape grooves 70C are located in front of the front ends 51C of the first slide grooves 50C. Incidentally, a non-woven fabric for improving feeling when the storage box 30C is moved or a soft material or the like for providing resistance may be added to the shafts 46C, the first slide grooves 50C, the second slide grooves 60C, and the escape grooves 70C.

The first walls 34C are formed in a circular arc shape so as not to come into contact with the top plate surface 41 when the storage box 30C swings.

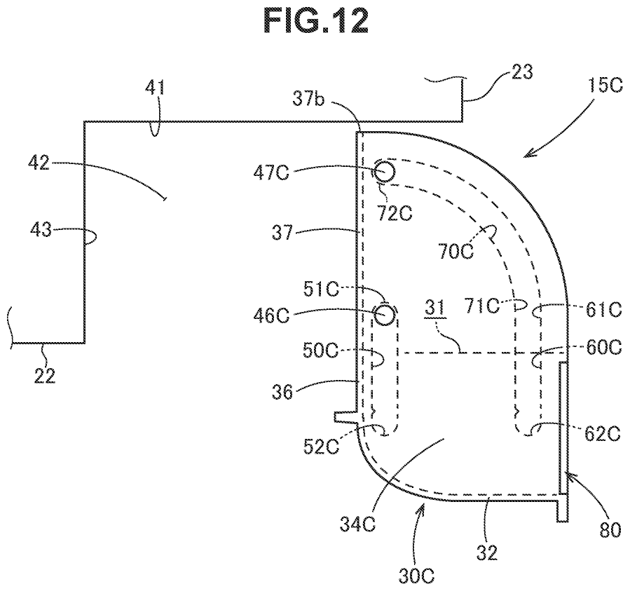

Referring to FIG. 12, a position where the storage box 30C in the slide completion position (refer to FIG. 11B) is swung downward and the occupant uses the storage box 30C is referred to as the use position. When the storage box 30C is in the use position, the shafts 46C are located at the front ends 51C of the first slide grooves 50C. The protrusions 47C are located at the second ends 72C of the escape grooves 70C. The escape grooves 70C may be provided with the above-described restrictions (not illustrated).

### Fifth Embodiment

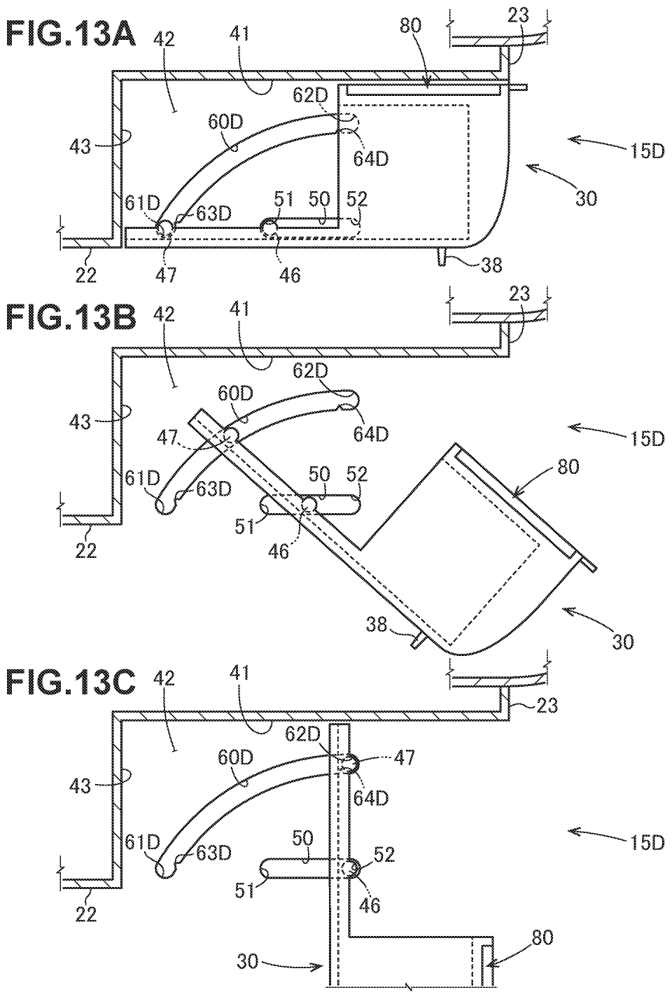

FIG. 13A illustrates an overhead console 15D according to a fifth embodiment. The same reference signs as in the first embodiment are assigned to configurations common to the overhead console 15 of the first embodiment, and the descriptions will be omitted.

The side wall surfaces 42 of the recess 40 include second slide grooves 60D in which the protrusions 47 are slidable. Front ends 61D of the second slide grooves are located in front of the first slide grooves. Rear ends 62D of the second slide grooves are located above the rear ends 52 of the first slide grooves 50.

When the storage box 30 is in the stored position, the shafts 46 are located at the front ends 51 of the first slide grooves 50, and the protrusions 47 are located at front ends 61D of the second slide grooves 60D. The second slide grooves 60D include restrictions 63D that restrict the protrusions 47 located at the front ends 61D of the second slide grooves 60D. The restrictions 63D are configured by protruding parts of wall surfaces of the second slide grooves 60D, thereby narrowing the width of the second slide grooves 60D. Incidentally, the position, number, and shape of the restrictions 63D are optional.

As illustrated in FIG. 13B, when the occupant grips the grip 38 and pulls the storage box 30, which is in the stored position, rearward, the shafts 46 slide with respect to the first slide grooves 50, and the protrusions 47 slide with respect to the second slide grooves 60D (slide position). In the slide position, as the shafts 46 moves rearward, the protrusions 47 move a rearward and upward direction. Namely, the storage box 30 in the slide position slides rearward and swings downward.

Referring to FIG. 13C, when the storage box 30 is located in the use position that is a position where the occupant uses the storage box 30, the shafts 46 are located at the rear ends 52 of the first slide grooves 50, and the protrusions 47 are located at the rear ends 62D of the second slide grooves 60D.

The second slide grooves 60D include restrictions 64D that restrict the protrusions 47 located at the rear ends 62D of the second slide grooves 60D. The restrictions 64D are configured by protruding parts of wall surfaces of the second slide grooves 60D, thereby narrowing the width of the second slide grooves 60D. Incidentally, the position, number, and shape of the restrictions 64D are optional.

Incidentally, the invention is not limited to the first to fifth embodiments as long as the actions and effects of the invention are achieved. The elements forming each of the embodiments can be combined with each other.

What is claimed is:

1. An overhead console comprising:
a panel provided on a ceiling of a passenger compartment; and
a storage box is configure to store in a recess of the panel,
wherein the storage box is locatable in a stored position where the storage box is stored in the recess and in a use position where the storage box is swung downward from the stored position and is usable by an occupant,
the panel is formed in a stepped shape in a vehicle height direction, and has a lower surface lower than a ceiling surface, and a connection surface connecting the lower surface and the ceiling surface,
the recess is formed from the lower surface to the connection surface of the panel,
a first slide groove extending in a vehicle front-rear direction is provided,
the storage box in the stored position comprises a bottom having an outer surface formed along the connection surface, a wall having an outer surface formed along the lower surface, and a shaft that protrudes in a vehicle width direction and that is slidable with respect to the first slide groove,
when the storage box is in the stored position, the shaft is located at a front end of the first slide groove, and
when the storage box is in the use position, the shaft is located at a rear end of the first slide groove.

2. The overhead console according to claim 1,
wherein the storage box comprises a protrusion protruding in the same direction as the shaft, and
the recess comprises a second slide groove in which the protrusion is slidable when the shaft slides with respect to the first slide groove, and an escape groove which is continuous with the second slide groove and through which the protrusion is passable when the storage box swings around the shaft.

3. The overhead console according to claim 1,
Wherein the wall of the storage box in the stored position comprises an extension extending forward from an edge of an opening of the storage box, and
the extension includes the shaft.

4. The overhead console according to claim 1,
wherein the storage box comprises a mirror that is usable by the occupant when the storage box is in the use position.

5. The overhead console according to claim 1,
wherein when the storage box is in the use position, a bottom surface of the storage box is substantially horizontal or is inclined forward and upward.

6. The overhead console according to claim 2,
wherein when the storage box is in the use position, a bottom surface of the storage box is substantially horizontal or is inclined forward and upward.

7. The overhead console according to claim 3,
wherein when the storage box is in the use position, a bottom surface of the storage box is substantially horizontal or is inclined forward and upward.

8. The overhead console according to claim 4,
wherein when the storage box is in the use position, a bottom surface of the storage box is substantially horizontal or is inclined forward and upward.

9. An overhead console comprising:
a panel provided on a ceiling of a passenger compartment; and
a storage box is configured to store in a recess of the panel,
wherein the storage box is locatable in a stored position where the storage box is stored in the recess and in a use position where the storage box is swung downward from the stored position and is usable by an occupant,
the panel is formed in a stepped shape in a vehicle height direction, and has a lower surface lower than a ceiling surface, and a connection surface connecting the lower surface and the ceiling surface,
the recess is formed from the lower surface to the connection surface of the panel,
a shaft protruding toward the storage box is provided,
the storage box in the stored position comprises a bottom having an outer surface formed along the connection surface, a wall having an outer surface formed along the lower surface, and a first slide groove which extends in a vehicle front-rear direction and relative to which the shaft is slidable,
when the storage box is in the stored position, the shaft is located at a rear end of the first slide groove, and
when the storage box is in the use position, the shaft is located at a front end of the first slide groove.

10. The overhead console according to claim 9,
wherein the recess comprises a protrusion protruding in the same direction as the shaft, and
the storage box comprises a second slide groove in which the protrusion is slidable when the shaft slides with respect to the first slide groove, and an escape groove which is continuous with the second slide groove and through which the protrusion is passable when the storage box swings around the shaft.

11. The overhead console according to claim 9,
wherein the storage box comprises a mirror that is usable by the occupant when the storage box is in the use position.

12. The overhead console according to claim 9,
wherein when the storage box is in the use position, a bottom surface of the storage box is substantially horizontal or is inclined forward and upward.
